(19) United States
(12) Patent Application Publication
(10) Pub. No.: US 2014/0360776 A1
(43) Pub. Date: Dec. 11, 2014

(54) CONDUIT CONNECTORS AND METHODS FOR MAKING AND USING THE SAME

(71) Applicant: Sigma Electric Manufacturing Corporation, Garner, NC (US)

(72) Inventors: Yuvraj Totaram Khodape, Pune (IN); Vinayak Manohar Chavan, Pune (IN)

(21) Appl. No.: 14/296,475

(22) Filed: Jun. 5, 2014

Related U.S. Application Data
(60) Provisional application No. 61/832,352, filed on Jun. 7, 2013.

(51) Int. Cl. H02G 15/06

(52) U.S. Cl. CPC H02G 15/06
USPC 174/657

(57) ABSTRACT

In one embodiment, the conduit connector can comprise: a body comprising an open side, wherein the body is capable of receiving a conduit in a receiving end, wherein the open side extends from a receiving end to a connecting end; a back component configured to engage and close a portion of the open side, wherein the back is moveable from an open to a closed position; a spring disposed around the connecting end, wherein the spring comprises one or more engagement tangs protruding away from the body and away from the connection end, wherein the tangs are spaced apart a distance greater than or equal to an opening diameter in a junction box; and an antishort bush located in and extending from the connecting end of the body.

### CROSS-REFERENCE TO RELATED APPLICATIONS AND PRIORITY CLAIM

This application is a U.S. Non-Provisional application which claims Priority to U.S. Provisional Application Ser. No. 61/832,352, entitled “CONDUIT CONNECTORS AND METHODS FOR MAKING AND USING THE SAME”, filed Jun. 7, 2013, which is incorporated herein by reference in its entirety.

### TECHNICAL FIELD

### Background

The most common use for electrical conduit connectors is to facilitate the connection of a conduit or cable to a junction box. The junction box can be a variety of electrical enclosures such as an outlet box, transformer enclosure, circuit panel, lighting fixture—the list is nearly endless. Similarly, the conduit can be rigid or flexible, or could be hose, other tubing capable of routing electrical wire, or cable. Cable can be non-metallic sheathed cable, portable cord, or a variety of other types of electrical conductors. The instant application is equally successful in connecting a plurality of types of conduits, cables, and other electrical conductors to a wide variety of boxes and other enclosures. Therefore, as used in this specification, the term conduit is not limited to standard rigid electrical conduit, but shall be intended to mean any type of conduit, any type of cable, or any other type of electrical conductor. Many commercial and residential buildings have electrical installations with many types of conduit-to-junction-box connections that utilize electrical connectors.

The two most common types of electrical connectors used are a snap-in connector, and a multipart connector which can be composed of two or more components that utilizes a threaded male end in conjunction with a threaded female locknut, hereinafter referred to collectively as a two-part locknut connector. In the case of the two-part locknut connector, the male threaded end is inserted into the junction box through a knockout (e.g., a hole or other opening). A rigid connection is established by threading the lock nut onto the male end in the junction box interior. The snap-in connector is another commonly used connector, which utilizes a snap ring to quickly connect it to the junction box. Either type of connector is integrated with an adapter end, which allows the attachment of conduit, cable, or a variety of types of hollow tubing.

The installation of electrical systems is generally expensive as an electrician must first install the enclosures, route conduit between each enclosure, and install connectors and then pull all necessary electrical wiring through the conduit. In other words, installation is expensive because it is labor intensive. The commercially available electrical connectors are one factor accentuating the labor intensiveness. Locknut connectors increase the cost of installing electrical systems for a number of reasons. The current art two-part locknut connectors are plagued with labor intensive problems. First, the locknut connectors are shipped from the manufacturer preassembled. That is, the electrician must first remove the locknut from the male end before it can be installed. Once the male end of the connector is placed through the knockout, the electrician must rethread the locknut onto the connector from the interior of the junction box.

Two hands are required to disassemble and then reassemble the connectors in the knockout. Consequently, it is difficult to hold a tool or a piece of conduit while reassembling the connector. Once the locknut is threaded it must be tightened. In accordance with many building codes and safety regulations, connectors must be firmly and reliably attached to junction boxes. To properly tighten the two-part locknut connector, the electrician must use a tool, usually a set of pliers or a screwdriver. Occasionally, when the proper tool is unavailable, an electrician will use any object within reach. These situations, while rare, raise serious safety issues. In many instances, however, to “get the job done” the locknut is “finger” tightened. Those persons skilled in the art know that finger tightened two-part locknut connectors can eventually loosen, and a loose connector can cause great strain to be put onto the electrical wires and their connections resulting in an increase in the probability of an electrical fire or other electrical problems, such as poor grounding.

Secondly, when the electrician disassembles the fitting by taking the locknut off the connector, the locknut can be dropped or misplaced. This can occur when the electrician is in an elevated position, such as, on a scissor lift or on scaffolding because the electrical conduit is often installed in out-of-the-way places like in rafters and above ceilings. If the locknut cannot be found, the connector is useless. If the electrician decides to retrieve the dropped locknut, the installation time is prolonged.

A third common problem with the present locknut connectors is the locknut is easily cross threaded onto the male thread. When this occurs, the electrician must usually use a tool to remove the locknut. On occasion, cross threading the locknut will damage the male threads on the connector making it difficult or impossible to reuse the connector. Again, the electrician must spend their time either removing the defective connector or forcing the locknut through the damaged portion of the threads.

A fourth problem with the present two-part locknut connectors is the distance the male end protrudes into the junction box. In some installations, the space inside the enclosure is already minimal. The space limitation becomes an acute problem when an additional connector is installed. The male threaded end protrudes well past the depth of the locknut and may interfere with another connector, the contents of the enclosure, or wiring inside the box. Therefore, in a limited space enclosure, the excess thread must be removed. Typically, the electrician may clip off some of the receptacle or mounting screws, or completes a combination of space enlarging modifications, all of which prolong installation time and threaten the integrity of the system as designed.

A fifth common problem with the present two-part locknut connectors occurs during disassembly of the connector from the enclosure. Electricians may disassemble an installation for a variety of reasons. The disassembly of the locknut connector is more time consuming than the installation. If the locknut was installed properly, that is, by tightening it with a tool, then the locknut must be removed with a tool. Similar to the installation, if the threads are damaged during disassembly, the connector is useless. Also similar to the installation problems, if the locknut is lost, it must be replaced if the connector is to be used again. The snap-in connector presents similar problems. However, the most significant problem is that these connectors, in most cases, do not create a rigid connection. Because the snap ring is sized to accept a variety of box wall thickness, it does not rigidly attach to many boxes. The loose fit may cause electrical continuity problems, a highly dangerous situation, since the box, the conduit, and the connector are intended to be part of the electrical grounding system in some applications.

A sixth problem with present two-part locknut connectors occurs when a conduit must be attached to a junction box at an angle. For example, if the only available hole in a junction box is in a direction that is not consistent with the direction the conduit runs. In this situation, the conduit will have to bend sharply in order to insert the connector into the hole. In instances where space is limited, this may not be possible.

There remains an unfulfilled need to provide a generally universal connector that is easy to use; e.g., which can be installed quickly and easily without tools, does not require access to the interior of the junction box, can be installed at an angle, and/or can be easily removed and reused in the box.

### BRIEF SUMMARY

Disclosed herein are conduit connectors and methods for making and using the same.

In one embodiment, the conduit connector can comprise a body comprising with an open side capable of receiving a conduit in a receiving end. The open side can extend from a receiving end to a connecting end. A back component can be configured to engage and close a portion of the open side, and the back component can be moveable from an open to a closed position. A spring can be disposed around the connecting end. The spring can comprises one or more engagement tangs protruding away from the body and away from the connection end and spaced apart a distance greater than or equal to an opening diameter in a junction box. The body can also include an antishort bush located in and extending from the connecting end of the body.

These and other features of the conduit connector and method will be understood from the drawings and description below.

### BRIEF DESCRIPTION OF THE DRAWINGS

Refer now to the figures, which are merely exemplary, not limiting, and wherein like elements are numbered alike.

FIG. 1. is a perspective view of an embodiment of a conduit connector.

FIG. 2 is a perspective view of the conduit connector of FIG. 1.

FIG. 3 is a cross-sectional view of the embodiment the conduit connector elements of FIG. 2.

FIG. 4 is a perspective view of the conduit connector of FIG. 1.

FIG. 5 is an exploded, disassembled, prospective view of an embodiment of a conduit connector of FIG. 1, conduit, and junction box.

FIG. 6 is an exploded, disassembled, prospective view of an embodiment of a conduit connector.

FIG. 7 is an exploded, disassembled, prospective view of an embodiment of a conduit connector of FIG. 6, conduit, and junction box.

FIG. 8 is a perspective view of the conduit connector of FIG. 6 connected to a junction box.

FIG. 9 an exploded, disassembled, prospective view of an embodiment of a conduit connector.

FIG. 10 is an exploded, disassembled, prospective view of an embodiment of the conduit connector of FIG. 9, conduit, and junction box.

FIG. 11 is a perspective view of the conduit connector of FIG. 9 connected to a junction box.

### DETAILED DESCRIPTION

Disclosed herein are conduit connectors capable of connecting to an enclosure, e.g., capable of connecting an electrical conduit to a junction box. The conduit connector comprises a body, a spring, and an antishort bush. The spring is situated around the connecting end of the body and can be held in place with a lip or protrusion at the end of the connecting end. The spring can include one or more tangs that extend away from the body and toward a receiving end of the body (i.e., away from the connecting end). The antishort bush can be located within the connecting end of the body. The antishort bush can include threads that correspond with threads located within the connecting end of the body. The conduit connector can also include a back component or clamp, which closes the body around a conduit. The back component can pivot to close, or can be removable. In addition, the back component can be locked onto the body through one or more tabs and corresponding openings. During use, the tangs of the spring extend into and hold the connector to a junction box, while the back component engages and retains the conduit inside the body.

The conduit connector answers a long felt need for an electrical connector which can be installed quickly and easily without tools and does not require access to the interior of a junction box. In addition, the conduit connector enables a connection to an enclosure (e.g., to an electrical junction box) at an angle. The conduit connector can also accommodate multiple conduits. The electrical connector has utility, among other uses, in the connection of a conduit to an enclosure through an opening in the side of the box commonly referred to as a knockout. Additionally, although this connector securely engages the enclosure and is not easily dislodged due to bumping or otherwise, it can be easily removed if desired. The conduit engagement region can cooperate with a variety of conduit, cables, and other electrical conductors.

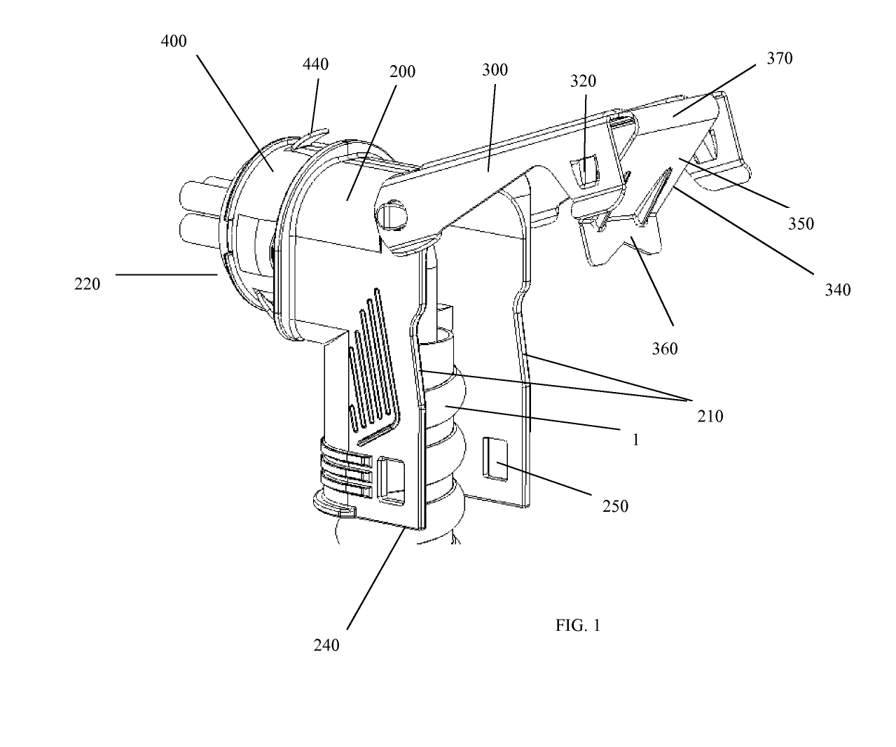

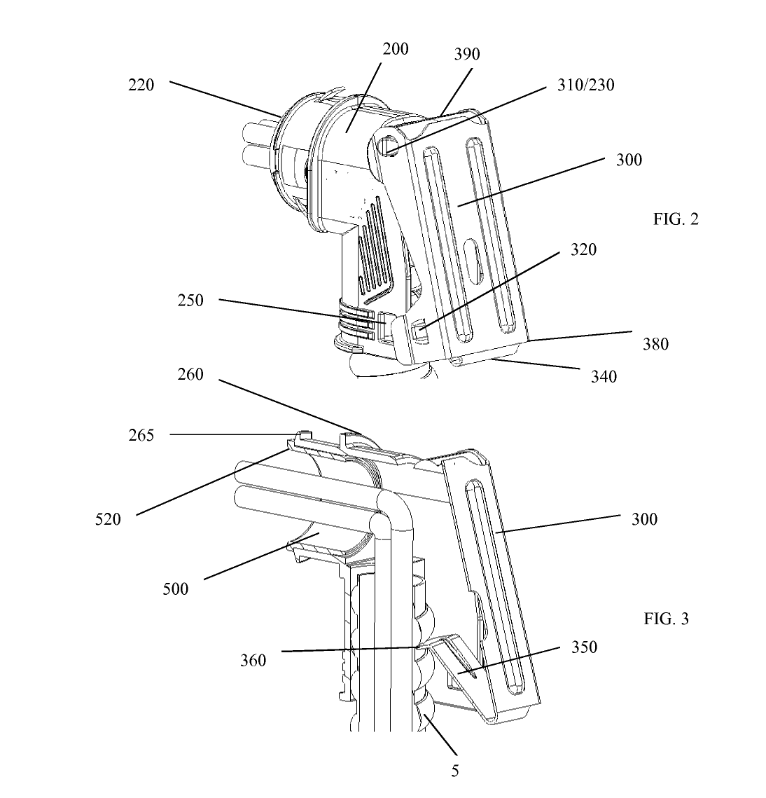

Referring now to FIGS. 1-5, these figures illustrate the overall view of a conduit connector along with a conduit and a junction box. FIG. 1 illustrates a conduit connector that allows the conduit to be installed at an angle to a junction box or other enclosure. As shown in FIG. 1 conduit 1 enters body 200 at receiving end 240. In addition, receiving end 240 is oriented at a different angle than connecting end 220. As shown in FIG. 1, the angle between receiving end 240 and connecting end 220 is approximately 90°. As shown in FIG. 2, body 200 also includes locking aperture 250, which can engage locking tab 320 on back component 300 to secure body 200 to back component 300.

A back component (or clamp) 300 is pivotally mounted on body 200 to close at least a portion of open side 210. Back component 300 can comprise a free end 380 and a pivot end 390. Back component 300 can close the entirety of open side 210. As illustrated in FIG. 1, back component 300 can include clip 340, which is configured to engage conduit 1. As shown in FIG. 1, clip 340 comprises a rounded portion 370 connected to back component 300, arm 350, and a protrusion 360. Back component 300 can include locking tabs 320 located on either side of back component 300. In addition, pivot apertures 310 can be located at a top portion of either side of back component 300. Pivot apertures 310 can be dimensioned to allow pivot tabs 230 to pass through. In operation, the back component can pivot open on pivot tabs 230 to allow access to body 200. For example, due to the right angle shape of body 200 depicted in FIG. 1, a conduit cannot be inserted directly through receiving end 240 to allow wires to extend out connecting end 220. Thus, back component 300 can be pivoted open, or optionally removed, to allow a conduit to be inserted into body 200.

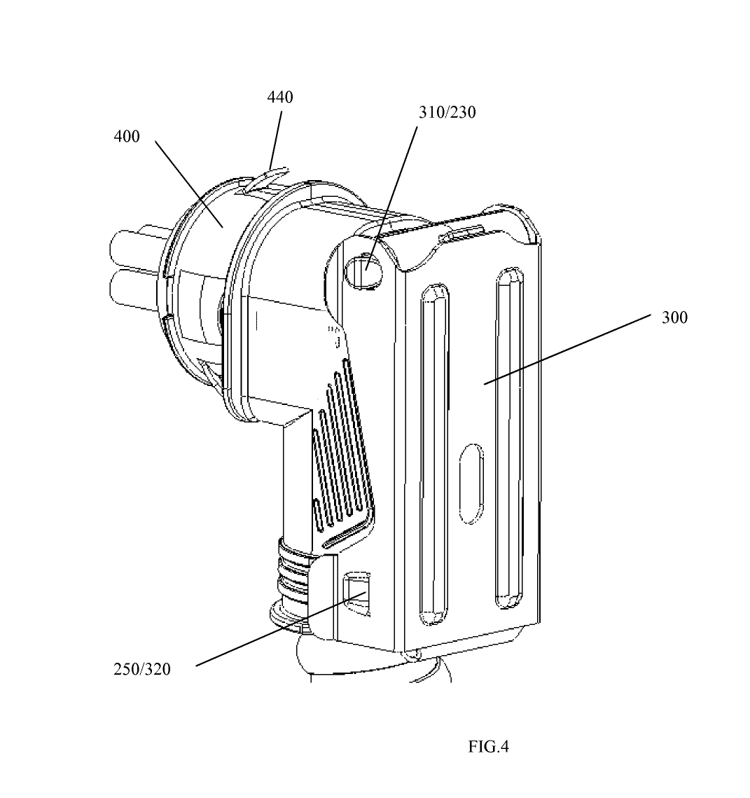

As discussed above, clip 340 can be configured to engage conduit 1. For example, as shown in FIG. 1, protrusion 360 can have a “V” shaped groove to engage ribs 5 on conduit 1. In an alternative, protrusion 360 can have a “U” shaped groove corresponding to the shape of ribs 5 on conduit 1. Protrusion 360 can be flat, rounded, and/or without a groove. As shown in FIG. 3, protrusion 360 extends in between ribs 5, which retains the conduit 1 within the conduit connector and prevents the conduit from being dislodged from the conduit connector. In operation, clip 340 is compressed when back component 300 is closed or pressed against body 200. The compression enables clip 340 to engage and retain conduit 1.

Spring 400 is mounted around connecting end 220. Spring 400 can include one or more tangs 440 that extend away from body 200 and connecting end 220. As shown in FIG. 3, lip 260 extends from the body a distance greater than the diameter of spring 240, allowing lip 260 to retain spring 400 on the body. In addition, spring lip 265 extends out ward from the end of connecting end 220, retaining spring 400 on the connecting end 220 of body 200.

As shown in FIG. 3, antishort bush 500 can be located within connecting end 220. Antishort bush can include projection 520, which engages the end of connecting end 220 and/or spring lip 265, retaining antishort bush 500 within body 200.

FIG. 4 illustrates the closed or locked position of the conduit connector. As shown in FIG. 4, back component 300 closes body 200. Locking tab 320 engages locking aperture 250 to secure back component 300 to body 200 (the reverse orientation is also contemplated with locking tabs on the body and apertures on the back component). Pivot tabs 230 can be oriented toward connecting end 220 further preventing separation of back component 300 from body 200.

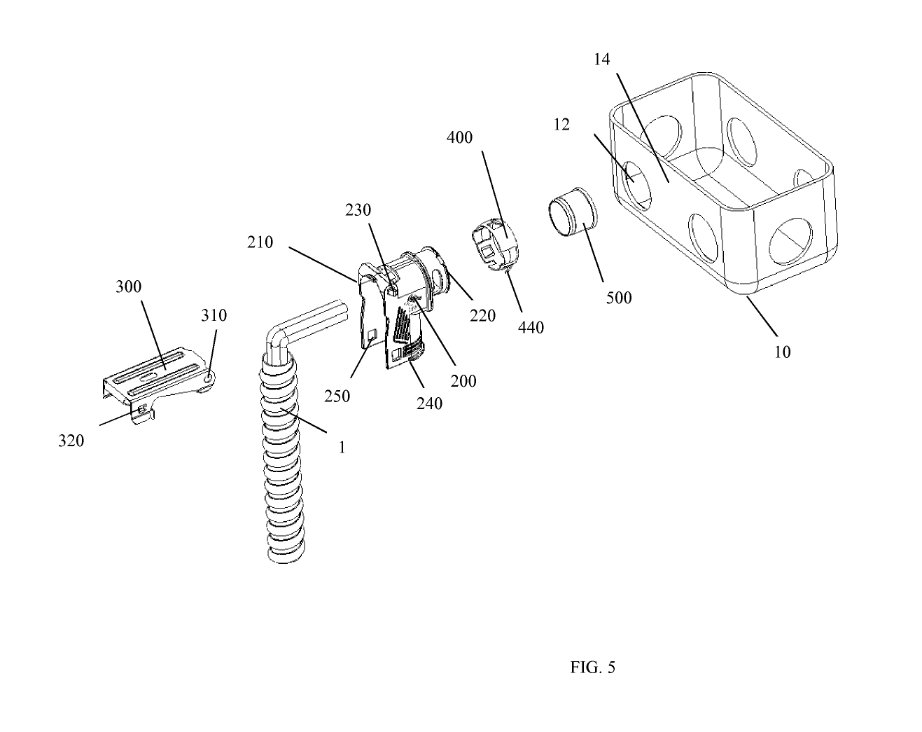

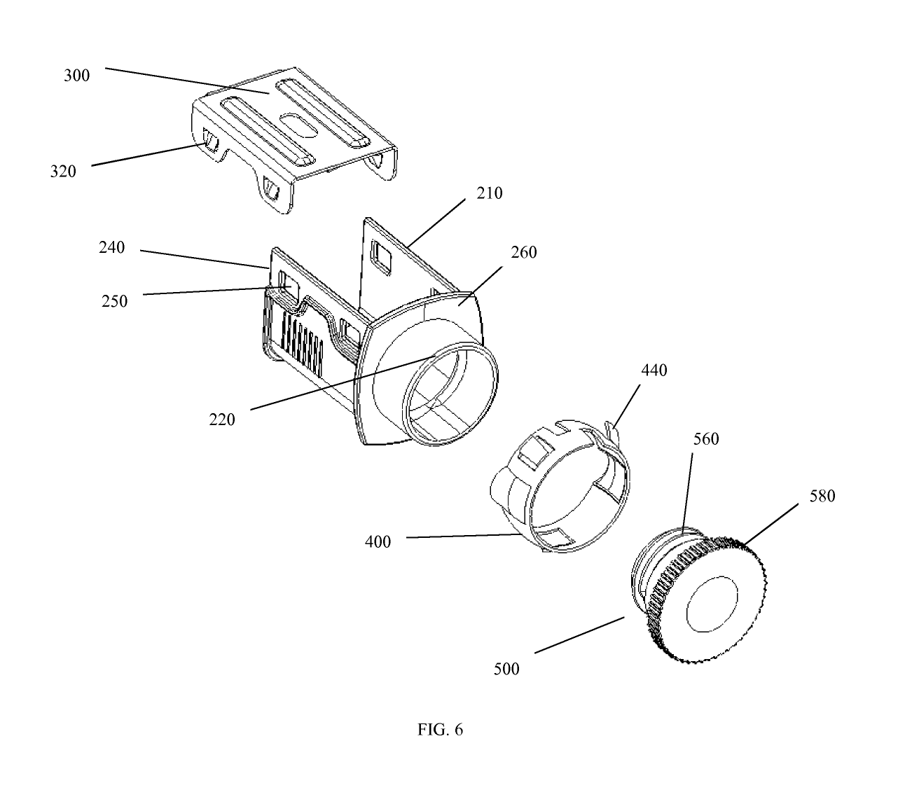

FIG. 5 provides an expanded view showing the junction box 10 located adjacent the connecting end 220 of the conduit connector, with a conduit 1 located adjacent the body 200. From the connecting end 220 to the receiving end 240, body 200 comprises an angle of approximately 90°. The conduit connector comprises antishort bush 500, spring 400, back component 300, and body 200.

In operation, the connector shown in FIG. 1 receives conduit 1 by pivoting back component 300 to an open position. Back component is pivoted closed as shown in FIG. 2, pressing clip 340 against conduit 1, as shown in FIG. 3, inhibiting the conduit 1 from becoming dislodged. During closing, locking tabs 320 on back component 300 engage locking apertures 250 on body 200 securing back component 300 to body 200. The closed conduit connector, shown in FIG. 4, attaches to the junction box 10. The conduit connector is inserted into junction box 10 through opening 12, and connecting tangs 440 on spring 400 engage an inner surface of wall 14 to prevent the inadvertent removal or dislodging of the conduit connector from the box. Stop lip 265 has a diameter greater that the diameter of opening 12, preventing the connector from further entering junction box 10.

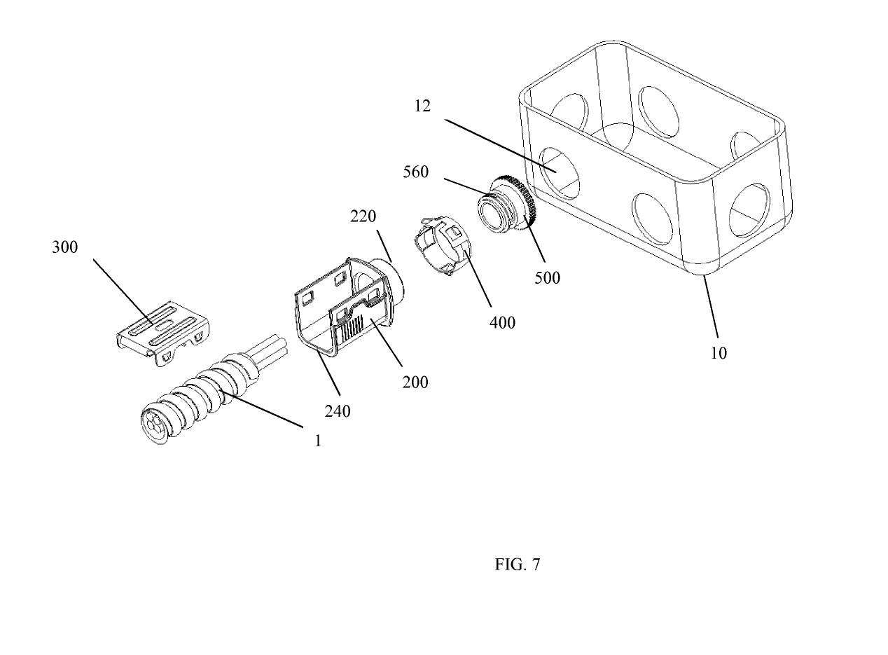

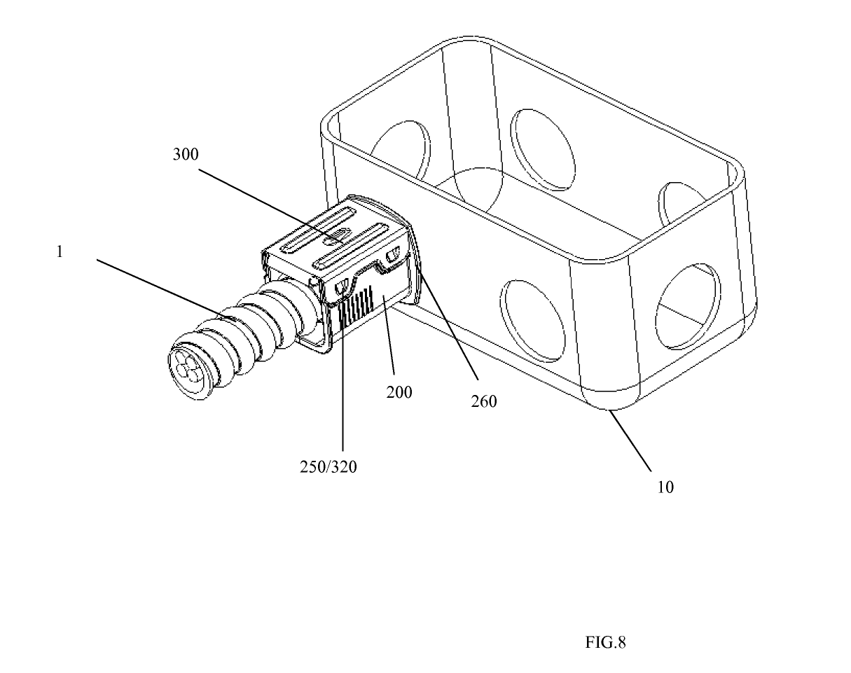

FIGS. 6 and 7 illustrate a conduit connection with a removable back component 300, which is configured to close at least a portion of open side 210. Back component 300 can be configured to close the entirety of open side 210. Body 200 includes one or more locking apertures 250 that are configured to mate with one or more locking tabs 320 on back component 300 (the reverse orientation is also contemplated with locking tabs on the body and apertures on the back component). Spring 400 is oriented around connecting end 220 of body 200. Spring 400 comprises one or more tangs 440 that extend away from body 200 and connecting end 220. Stop lip 260 extends from body 200 and prevents movement of spring 400 toward receiving end 240. As shown in FIG. 6, antishort bush 500 comprises threads 560 and grip 580. Threads 560 are configured to engage corresponding threads within connection end 220. Grip 580 is dimensioned to retain spring 400 on connection end 220. For example, as shown in FIG. 6, grip 580 has a diameter greater than spring 400. The grip 580 is formed from a textured surface around the periphery of an end of antishort bush, opposite the end that extends into the body. The textured surface can be a series of grooves that extend parallel to a channel through the connecting end 220.

As shown in FIG. 8, conduit 1 is inserted in receiving end 240. The conduit connector is inserted into junction box 10 through an opening. Locking tabs 320 engage locking apertures 250 securing back component 300 to body 200 (the reverse orientation is also contemplated with locking tabs on the body and apertures on the back component). Stop lip 260 prevents the conduit connection from fully entering junction box 10. In operation, the connecting tangs 440 on spring 400 engage an inner surface of junction box 10 to prevent the inadvertent removal or dislodging of the conduit connector from the box. In the event that the conduit connector has to be removed, antishort bush 500 can be unscrewed from connecting end 220 and spring 400 can be separated from connecting end 220. Thus, the conduit connector can be removed with the body and back portion intact. Subsequent attachment to a junction box merely requires the reattachment of spring 400 and bush 500.

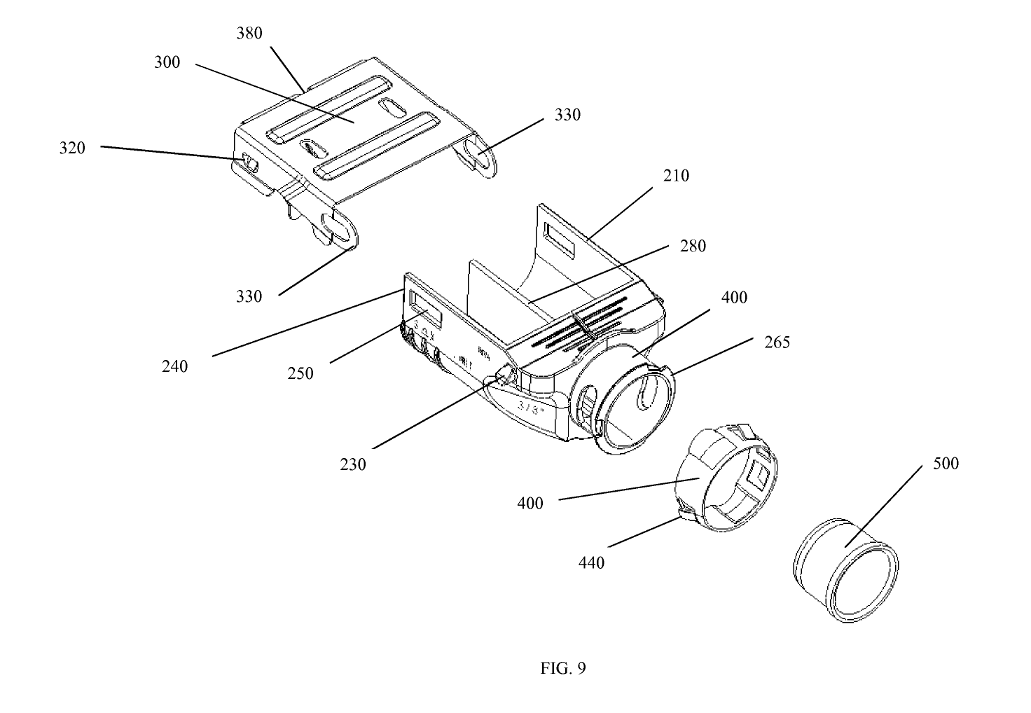

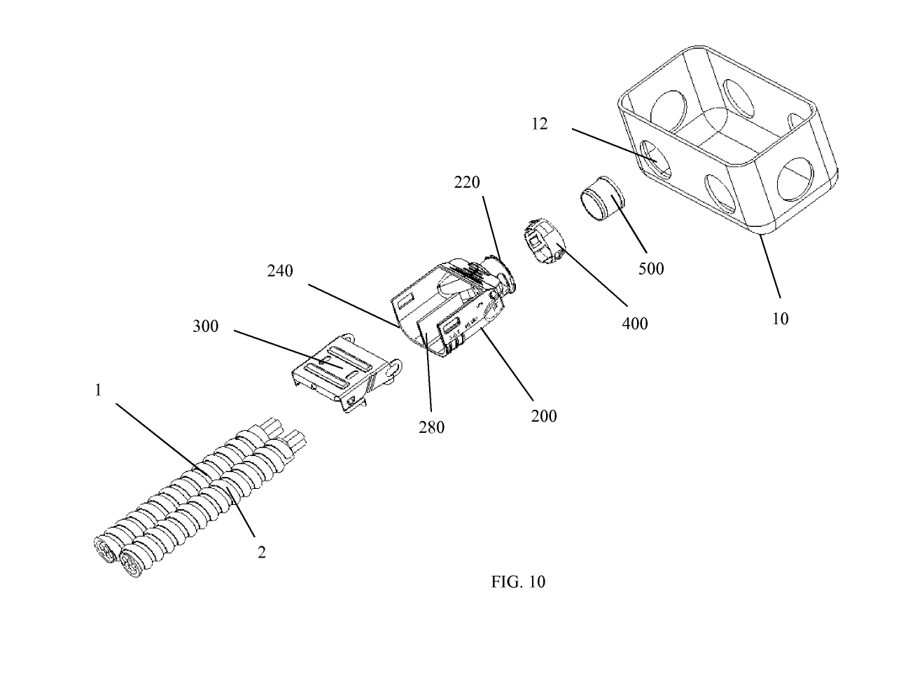

FIGS. 9-11 illustrate body 200 that is capable of housing multiple conduits. Body 200 can comprise a divider 280 to separate conduits within the body. As shown in FIG. 9, back component 300 comprises pivot protrusions 360 that extend from the end of back component 300. Pivot protrusion 360 can be angled toward the center of back component 300. Within pivot protrusion 360, pivot aperture 330 is configured to engage a pivot tab 230 on body 200. Pivot aperture 330 can be elongated to allow movement of pivot tab 230 within pivot aperture 330 (toward or away from free end 380 of back component 300). In operation, pivot tab 230 engages pivot aperture 330 at a point closest to free end 380. In this orientation, back component 300 is able to pivot from an open to a closed position on body 200. To prevent the pivot motion, back component 300 can be moved in the direction of free end 380 sliding pivot tab 230 to an opposite end of pivot aperture 330. In this position, due to the angled nature of the pivot protrusion, the back component is prevented from pivoting on pivot tab 230.

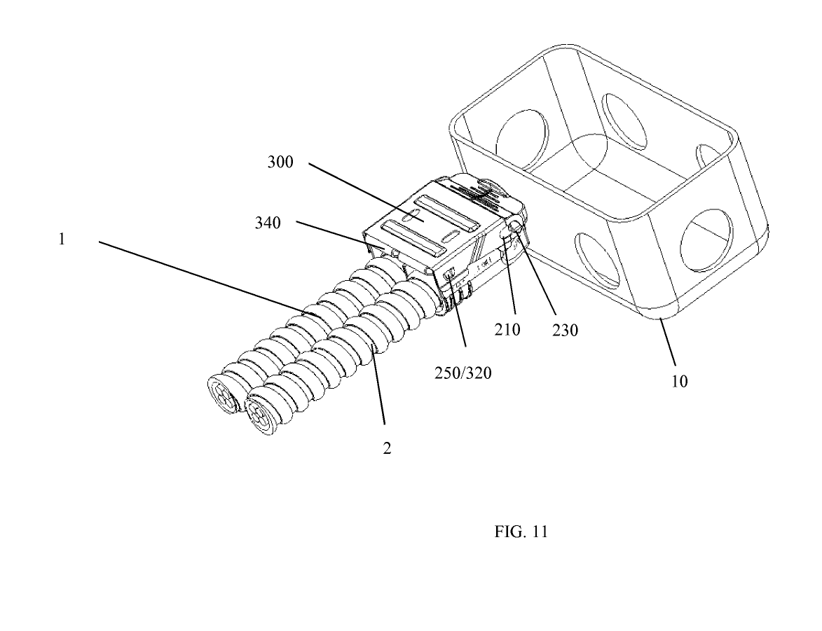

As shown in FIG. 10, the conduit connector receives conduits 1 and 2 at receiving end 240. Spring 400 is oriented around connection end 220, and antishort bush 500 is configured to engage connection end 220. Divider 280 is positioned to receive and separate conduits 1 and 2. As illustrated in FIG. 11, back component 300 is secured to body 200 through locking tabs 320 engaging locking apertures 250 (the reverse orientation is also contemplated with locking tabs on the body and apertures on the back component). In addition, pivot tab 230 is positioned in a locked position within pivot aperture 310, and prevented from pivoting as described above.

The conduit connector can be formed of various materials as appropriate for the particular element. For example, the body can comprise a metal or metal alloy, such as zinc, aluminum, steel, as well as combinations comprising at least one of the foregoing (e.g., zinc alloy, aluminum alloy, and/or steel alloy). The spring can comprise a material such as steel, (e.g., spring steel and/or stainless steel), as well as combinations comprising at least one of the foregoing. The antishort bush can be formed of a plastic, such as engineering plastics.

The embodiments described above are interchangeable. For example, the conduit connector can comprise a combination of any of the springs, back components, bodies, or antishort bushes described above. For example, the double conduit connector described above in reference to FIGS. 9-11 can also include the antishort bush of FIG. 6 and/or the angled body described above in reference to FIG. 1. Likewise, the angled body described in reference to FIG. 1 can include the antishort bush of FIG. 6. Furthermore, all embodiments can include the clip on the back component described above for retaining the conduit within the conduit connector. In addition, any component designed to interact with another component can be contemplated in reverse positions. For example, the pivot tabs on the body can be located on the back component, and the pivot apertures on the back component can be located on the body.

Set forth below are some embodiments of the conduit connector and methods of using the same.

### Embodiment 1

A conduit connector, comprising: a body comprising an open side, wherein the body is capable of receiving a conduit in a receiving end, wherein the open side extends from a receiving end to a connecting end; a back component configured to engage and close a portion of the open side, wherein the back is moveable from an open to a closed position; a spring disposed around the connecting end, wherein the spring comprises one or more engagement tangs protruding away from the body and away from the connection end, wherein the tangs are spaced apart a distance greater than or equal to an opening diameter in a junction box; and an antishort bush located in and extending from the connecting end of the body.

### Embodiment 2

The conduit connector of Embodiment 1, wherein the body comprises apertures configured to receive tabs on the back component and prevent movement of the back component.

### Embodiment 3

The conduit connector of Embodiments 1 or 2, wherein the back component comprises a free end and a pivoting end, wherein the pivoting end comprises apertures configured to receive tabs on the body.

### Embodiment 4

The conduit connector of Embodiment 3, wherein the apertures are formed in protrusions that extend from a pivoting end of the back component, wherein the tabs are angled toward a centerline of the back that runs from the pivoting end to a free end, and wherein the apertures are configured to slide on the tabs on the body from a pivoting position to a locked position.

### Embodiment 5

The conduit connector of any of Embodiments 1-3, wherein the back component comprises an engagement member configured to engage the conduit.

### Embodiment 6

The conduit connector of Embodiment 5, wherein the engagement member retains the conduit within the body.

### Embodiment 7

The conduit connector of any of Embodiments 1-6, wherein a first portion of the body comprising the receiving end is angled with respect to a second portion of the body comprising the connecting end.

### Embodiment 8

The conduit connector of Embodiment 7, wherein the first portion is angled 90 degrees from the second portion.

### Embodiment 9

The conduit connector of any of Embodiments 1-8, wherein the antishort bush comprises a first portion with a diameter smaller than the connecting end of the body, wherein the first portion comprises grooves that correspond to grooves located within the connecting end of the body.

### Embodiment 10

The conduit connector of Embodiment 9, wherein the antishort bush comprises a second portion extending from the connecting end with a diameter greater than the diameter of the connecting end.

### Embodiment 11

The conduit connector of any of Embodiments 1-10, wherein the connecting end comprises a lip with a diameter greater than an opening diameter in a junction box.

### Embodiment 12

The conduit connector of any of Embodiments 1-11, wherein the body comprises a divider that separates the receiving end into at least two portions, wherein each portion is capable of receiving a conduit.

### Embodiment 13

The conduit connector of any of Embodiments 1-12, wherein the connecting end comprises a second lip with a diameter greater than or equal to the diameter of the spring.

### Embodiment 14

The conduit connector of Embodiment 13, wherein the second lip prevents the spring from dislodging from the connecting end.

### Embodiment 15

The conduit connector of any of Embodiments 1-14, wherein the antishort bush further comprises threads configures to engage threads on an interior surface of the body.

### Embodiment 16

The conduit connector of any of Embodiments 1-15, wherein the antishort bush further comprises grip extending around a periphery of an end of antishort bush, opposite the end that extends into the body.

### Embodiment 17

The conduit connector of any of claims 1-16, wherein the body has two parallel channels such that different conduits can be located in each channel, and wherein the back component comprises an engagement member configured to engage each of the conduits.

### Embodiment 18

A method of connecting a conduit to a junction box, comprising: extending an end of the conduit through a receiving end, through a body, and through a connecting end of a conduit connector; closing a back component to engage the conduit in the body with a clip protrusion extending from a clip arm on a back component, wherein the back component connects to the body with a tab; introducing the connecting end to an opening in the junction box such that the conduit and the connecting end extend through the opening, into the junction box; an dengaging an inner surface of the junction box with locking tabs on a spring that extends around the outer surface of the connecting end.

### Embodiment 19

The method of claim 18, wherein the conduit end extends out of the connecting end at an angle of about 90° compared to the angle the conduit end entered the receiving end.

### Embodiment 20

The method of any of claims 18-19, wherein, after engaging the inner surface of the junction box, further comprising unscrewing an antishort bush from the connecting end, removing the spring, and removing the connecting end from the opening.

### Embodiment 21

The method of claim 20, further comprising reattaching the conduit connector to the junction box by placing the spring onto the connecting end, screwing the antishort bush into the connecting end, and inserting the connecting end through the opening.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). The terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A conduit connector, comprising:
a body comprising an open side, wherein the body is capable of receiving a conduit in a receiving end, wherein the open side extends from a receiving end to a connecting end;
a back component configured to engage and close a portion of the open side, wherein the back is moveable from an open to a closed position;
a spring disposed around the connecting end, wherein the spring comprises one or more engagement tangs protruding away from the body and away from the connection end, wherein the tangs are spaced apart a distance greater than or equal to an opening diameter in a junction box; and
an antishort bush located in and extending from the connecting end of the body.

2. The conduit connector of claim 1, wherein the body comprises apertures configured to receive tabs on the back component and prevent movement of the back component.

3. The conduit connector of claim 1, wherein the back component comprises a free end and a pivoting end, wherein the pivoting end comprises apertures configured to receive tabs on the body.

4. The conduit connector of claim 3, wherein the apertures are formed in protrusions that extend from a pivoting end of the back component, wherein the tabs are angled toward a centerline of the back that runs from the pivoting end to a free end, and wherein the apertures are configured to slide on the tabs on the body from a pivoting position to a locked position.

5. The conduit connector of claim 1, wherein the back component comprises an engagement member configured to engage the conduit.

6. The conduit connector of claim 5, wherein the engagement member retains the conduit within the body.

7. The conduit connector of claim 1, wherein a first portion of the body comprising the receiving end is angled with respect to a second portion of the body comprising the connecting end.

8. The conduit connector of claim 7, wherein the first portion is angled 90 degrees from the second portion.

9. The conduit connector of claim 1, wherein the antishort bush comprises a first portion with a diameter smaller than the connecting end of the body, wherein the first portion comprises grooves that correspond to grooves located within the connecting end of the body.

10. The conduit connector of claim 9, wherein the antishort bush comprises a second portion extending from the connecting end with a diameter greater than the diameter of the connecting end.

11. The conduit connector of claim 1, wherein the connecting end comprises a lip with a diameter greater than an opening diameter in a junction box.

12. The conduit connector of claim 1, wherein the body comprises a divider that separates the receiving end into at least two portions, wherein each portion is capable of receiving a conduit.

13. The conduit connector of claim 1, wherein the connecting end comprises a second lip with a diameter greater than or equal to the diameter of the spring.

14. The conduit connector of claim 13, wherein the second lip prevents the spring from dislodging from the connecting end.

15. The conduit connector of claim 1, wherein the antishort bush further comprises threads configures to engage threads on an interior surface of the body.

16. The conduit connector of claim 1, wherein the antishort bush further comprises grip extending around a periphery of an end of antishort bush, opposite the end that extends into the body.

17. The conduit connector of claim 1, wherein the body has two parallel channels such that different conduits can be located in each channel, and wherein the back component comprises an engagement member configured to engage each of the conduits.

18. A method of connecting a conduit to a junction box, comprising:
extending an end of the conduit through a receiving end, through a body, and through a connecting end of a conduit connector;
closing a back component to engage the conduit in the body with a clip protrusion extending from a clip arm on a back component, wherein the back component connects to the body with a tab;
introducing the connecting end to an opening in the junction box such that the conduit and the connecting end extend through the opening, into the junction box;
engaging an inner surface of the junction box with locking tabs on a spring that extends around the outer surface of the connecting end.

19. The method of claim 18, wherein the conduit end extends out of the connecting end at an angle of about 90° compared to the angle the conduit end entered the receiving end.

20. The method of claim 18, wherein, after engaging the inner surface of the junction box, further comprising unscrewing an antishort bush from the connecting end, removing the spring, and removing the connecting end from the opening.

21. The method of claim 20, further comprising reattaching the conduit connector to the junction box by placing the spring onto the connecting end, screwing the antishort bush into the connecting end, and inserting the connecting end through the opening.
